(19) United States
(12) Patent Application Publication
(10) Pub. No.: US 2006/0090587 A1
(43) Pub. Date: May 4, 2006

(54) Steering column arrangement for a motor vehicle, in particular a tracked vehicle

(76) Inventors: Helmut Kanzler, Voehringen-Illerberg (DE); Franz Mack, Kichdorf/Iller (DE); Andreas Weidenkopf, Neu-Ulm (DE)

Correspondence Address: FLYNN THIEL BOUTELL & TANIS, P.C., 2026 RAMBLING ROAD, KALAMAZOO, MI, 49008-1631, US

(21) Appl. No.: 11/263,334

(22) Filed: Oct. 31, 2005

(30) Foreign Application Priority Data
Nov. 3, 2004 (DE) 202004017086.8

(51) Int. Cl. B62D 1/18

(52) U.S. Cl. 74/493; 280/775

(57) ABSTRACT

The invention relates to a steering column arrangement for a motor vehicle, in particular a tracked vehicle, with a steering wheel, assigned to which are means for the electrical or electronic transmission of steering movements of the steering wheel to a vehicle control system, and the steering wheel being arranged in a rotationally movable manner on an upper steering column part, which is held adjustably in relation to a lower steering column part arranged fixedly on the vehicle. Means for vertical adjustment and means for longitudinal adjustment are provided between the lower steering column part and the upper steering column part, in order to adjust the upper steering column part in its height and in its length in relation to the position of the driver's seat.

### FIELD OF THE INVENTION

The invention relates to a steering column arrangement for a motor vehicle, in particular a tracked vehicle, with a steering wheel, assigned to which are means for the electrical or electronic transmission of steering movements of the steering wheel to a vehicle control system, and the steering wheel being arranged in a rotationally movable manner on an upper steering column part, which is held adjustably in relation to a lower steering column part arranged fixedly on the vehicle.

### BACKGROUND OF THE INVENTION

A tracked vehicle, which is used in particular for the preparation and formation of ski runs, has a driver's cab, in which a driver's seat is accommodated. Assigned to the driver's seat, in a way that is known in principle, is a steering wheel, which is mounted in a rotatable manner on a steering column. A major feature of steering devices for such tracked vehicles is that the steering wheel is coupled to a corresponding vehicle control system by electrical or electronic transmission means, so that, by contrast with wheeled motor vehicles, there is no mechanical transmission of steering movements of the steering wheel to a corresponding vehicle control system. In the case of tracked vehicles, moreover, a steering wheel movement leads to hydraulic motors of the opposite sides of the tracked running gear being individually activated correspondingly by means of a hydraulic system of the vehicle and achieving the desired vehicle movement in this way. When traveling straight ahead, both chains are activated evenly. When traveling in a curve, one of the two chains is moved at a changed speed with respect to the other chain. Finally, when the steering wheel is turned fully in one direction, it is possible to allow the chains to run in opposite directions and in this way achieve rotation of the tracked vehicle about a vertical axis of the vehicle. Steering wheels of tracked vehicles of this type are not adjustable in relation to a corresponding position of the driver's seat.

In the case of wheeled motor vehicles, in particular passenger cars, it is also known to arrange steering columns in such a way that they are adjustable vertically and longitudinally, in order to allow individual adaptation to different seat positions of a driver.

### SUMMARY OF THE INVENTION

The object of the invention is to provide a steering column arrangement of the type mentioned at the beginning which allows ergonomic adaptation of the steering wheel to different seat positions of a driver of the motor vehicle.

This object is achieved by means for vertical adjustment and means for longitudinal adjustment being provided between the lower steering column part and the upper steering column part, in order to adjust the upper steering column part in its height and in its length in relation to the position of the driver's seat. This allows individual and ergonomically favorable adaptation of the steering wheel position to different seat positions of the respective driver of the motor vehicle. The solution according to the invention is suitable particularly advantageously for a steering device of a tracked vehicle, in particular a ski-run vehicle for the preparation and formation of skiing areas. The means for longitudinal adjustment serve the purpose of changing a distance between the steering wheel and the driver of the tracked vehicle in his corresponding sitting position on a driver's seat along the axis of rotation of the steering wheel and preferably substantially in the longitudinal direction of the vehicle. The means for vertical adjustment are intended to bring about substantially a displacement of the steering wheel position radially in relation to the axis of rotation of the steering wheel and substantially in the vertical direction of the vehicle. It is possible alternatively to adjust the steering wheel either in its height or in its longitudinal position, or else simultaneously bring about a longitudinal adjustment and a vertical adjustment.

In a refinement of the invention, the means for vertical adjustment and the means for longitudinal adjustment comprise a kinematic pivoted lever mechanism, by means of which the upper column part is articulated on the lower column part. The kinematic pivoted lever mechanism allows both a vertical adjustment and a longitudinal adjustment.

In a further refinement of the invention, the kinematic pivoted lever mechanism is assigned driving means, which are provided for the actuation of the kinematic pivoted lever mechanism. The driving means are preferably of a hydraulic or pneumatic configuration. In the same way, however, they may also be of an electrical or mechanical form. At least one hydraulically or pneumatically actuated adjusting cylinder is preferably provided as the driving means.

In a further refinement of the invention, actuating means that can be operated by an operator are provided for the driving means. The actuating means are used to activate the driving means in order to bring about a corresponding vertical adjustment and/or longitudinal adjustment.

In a further refinement of the invention, the means for vertical adjustment and the means for longitudinal adjustment are respectively assigned a separate driving unit, which can be individually activated by a separate actuating means in each case. This makes it possible to bring about optionally either a vertical adjustment or longitudinal adjustment or a combined vertical and longitudinal adjustment.

In a further refinement of the invention, the kinematic pivoted lever mechanism has a parallelogram linkage unit. The parallelogram linkage unit serves the purpose of displacing the upper steering column part at least largely parallel in relation to the lower steering column part. This allows a longitudinal adjustment of the steering wheel in particular.

In a further refinement of the invention, the kinematic pivoted lever mechanism has a supporting arm, which is articulated in a pivotably movable manner on the upper column part on the one hand and on the lower column part on the other hand. The supporting arm is preferably arranged at its end on the upper steering column part and is of a stable configuration.

In a further refinement of the invention, the actuating means is formed as a pedal. Preferably, both actuating means are respectively configured as pedals that can be actuated independently of each other. The actuating means are preferably used to release an arrestment of the means for vertical adjustment and/or the means for longitudinal adjustment, so that the desired displacing movement of the steering wheel can be performed either by subsequently taking hold of the steering wheel and moving it manually, or by the release of the arrestment having the effect that the driving means automatically actuate the kinematic pivoted lever mechanism until the steering wheel has reached the desired position. Subsequently, an automatic return of the actuating means into the arresting or blocking position is brought about by letting go of the actuating means. The driving means may also assist the manual displacing movement of the steering wheel, in that they apply assisting pivoted lever forces, without the necessary lever forces for displacing the steering wheel being applied completely by the driving means.

In an advantageous refinement, the kinematic pivoted lever mechanism is assigned blocking means, in order to arrest the upper steering column part with respect to the lower steering column part in a functional position. This allows reliable fixing of the upper steering column part in the position individually set in each case.

### BRIEF DESCRIPTION OF THE DRAWINGS

Further advantages and features of the invention emerge from the claims and from the following description of a preferred exemplary embodiment of the invention, which is represented on the basis of the drawings.

FIG. 1 shows in a side view an embodiment of a steering column for a tracked vehicle with a bearing device according to the invention for a steering wheel of the steering column and

FIG. 2 shows the steering column from FIG. 1 in a perspective representation.

### DETAILED DESCRIPTION OF THE INVENTION

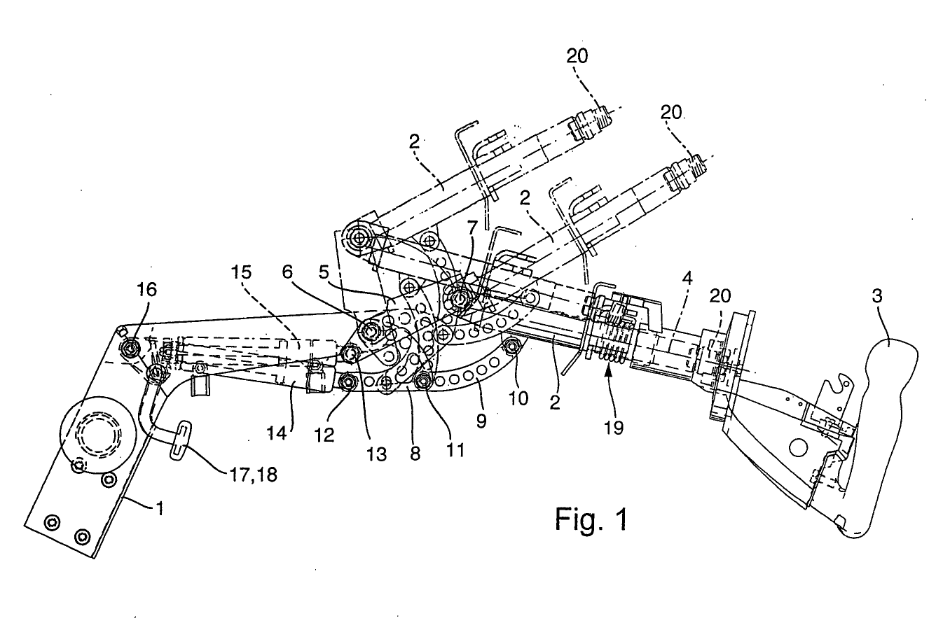

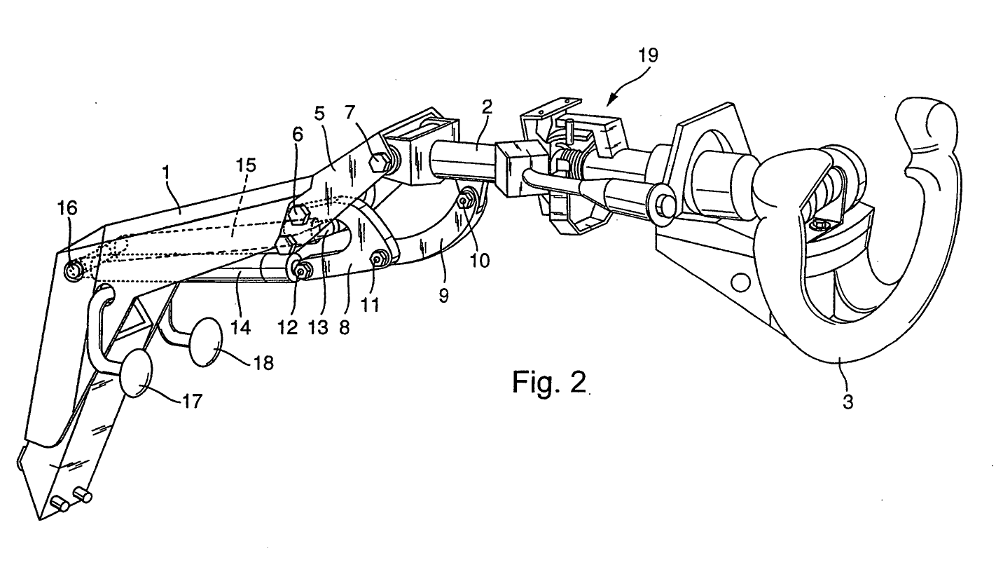

A steering column arrangement according to FIGS. 1 and 2 is provided in a driver's cab of a tracked vehicle for the preparation and formation of skiing areas. The steering column arrangement is positioned in a way known in principle in front of a driver's seat—seen in the forward-directed traveling direction of the tracked vehicle. The steering column arrangement has a rotationally movable steering wheel 3, which is mounted in a rotationally movable manner about a steering axis 4 on an upper steering column part 2. The steering wheel 3 is electrically or electronically in connection with a vehicle control system by means of a turning-angle acquisition and transmission unit designated as a whole by 19. By means of the steering-angle acquisition and transmission unit 19, steering movements of the steering wheel 3 are acquired in an electrical or electronic way by means of corresponding signal and control lines and used in an electronic control unit of the vehicle control system for corresponding activation commands for a hydraulic system of the vehicle and in particular for activation of hydraulic motors of a right-hand and a left-hand tracked running gear.

The upper steering column part 2 is adjustably held on a lower steering column part 1 by means of a kinematic pivoted lever mechanism 5 to 13. The lower steering column part 1 is mounted fixedly on the vehicle, in that it is preferably fastened to a vehicle floor or some other load-bearing part of the driver's cab. The lower steering column part 1 has a cross-sectionally U-shaped, dimensionally stable supporting section, in particular a metal section, which in the mounted state of the lower steering column part is open toward the rear—with respect to a longitudinal axis of the vehicle. The upper steering column part 2 is articulated on the lower steering column part 1 on the one hand by means of a supporting lever 5, which is mounted in a pivotably movable manner, about a pivoting axis running in the transverse direction of the vehicle, on an end region remote from the steering wheel 3. In a vertical plane of the vehicle, the overall steering column arrangement is aligned rearward in the longitudinal direction of the vehicle and upward in the vertical direction of the vehicle.

The supporting lever 5 is formed by a leg section, which engages over the outside of the metal section of the lower steering column part 1 on both sides and, by means of a bearing pin 6 at a distance from the point of articulation 7 of the upper steering column part 2, is also arranged in a pivotably movable manner on the lower steering column part 1. The bearing pin 6 is aligned parallel to the pivoting axis of the point of articulation 7. The bearing pin 6 consequently forms a second point of articulation for the supporting lever 5. By means of a forked link 8 and a parallel rocker 9, together with the supporting lever 5, a parallelogram linkage unit is created for the upper steering column part 2. The parallel rocker 9 is arcuately curved and is connected on the upper steering column part 2 by means of an upper bearing point 10 and to the forked link 8 by means of a lower bearing point 11. The points of articulation 6 and 11 and also 7 and 10 approximately define a parallelogram. One fork leg of the forked link 8 extends between the point of articulation 6 of the lower steering column part 1 and the point of articulation 11, at which the forked link 8 is connected to the parallel rocker 9. In the region of all the points of articulation 6, 7, 10, 11, the respective parts of the kinematic pivoted lever mechanism are mounted in a pivotably movable manner in relation to one another.

The support of the upper steering column part 2, and consequently of the kinematic pivoted lever mechanism, in a respectively set functional position is performed by two adjusting cylinders 14, 15 in the form of hydraulic cylinders, the cylinder parts of which are supported in a pivotably movable manner on a bearing bolt 16 fixedly connected to the lower steering column part 1. A pivoting axis of the bearing bolt 16 is aligned parallel to the pivoting axes of the various points of articulation 6, 7, 10, 11. A piston part of the adjusting cylinder 14 acts with its end on a free fork continuation of the forked link 8 and is connected to the latter in a pivotably movable manner by means of a pivot point 12. A piston part of the adjusting cylinder 15 acts in a pivotably movable manner on a pivot point 13 in the region of a lever continuation of the supporting lever 5 on the side opposite from the point of articulation 7 in relation to the point of articulation 6. The adjusting cylinders 14, 15 are pressure-loaded in their respective position of rest, so that they can support any position of the kinematic pivoted lever mechanism that can be assumed and accordingly arrest it. A movement of the piston parts of the adjusting cylinders 14, 15 leads to pivoting movements of the supporting lever 5, of the forked link 8 and of the parallel rocker 9, whereby positional changes of the upper steering column part 2 are automatically achieved according to the dash-dotted representations in FIG. 1, selected by way of example.

The adjusting cylinders 14, 15 are arrested in the respectively set functional position or position of rest of the steering column arrangement, so that no relative movements of the piston parts are possible in relation to the assigned cylinder parts. This achieves reliable support and blocking of the kinematic pivoted lever mechanism in the respectively set position. To allow a displacement of the upper steering column part 2, the arrestment of each adjusting cylinder 14, 15 can be released. Provided as actuating means for this purpose are two pedals 17, 18, which in the mounted position of the steering column arrangement are arranged in a foot well in front of the driver's seat. In each case, a pedal 17, 18 is respectively assigned to one of the two adjusting cylinders 14, 15, so that actuation of the respective pedal 17, 18 brings about release of the arrestment of the respective adjusting cylinder 14, 15. At the same time, corresponding pressure actuation of the respective adjusting cylinder 14, 15 becomes effective, so that a corresponding hydraulic pressure can move the respective piston part and accordingly allow a displacement of the upper steering column part 2. Preferably, the hydraulic adjusting cylinders 14, 15 merely serve for supporting a displacing movement of the upper steering column part 2, so that an operator can move the steering wheel 3 and the upper steering column part 2 by expending relatively little force, almost with a floating kind of action. The displacing movement of the upper steering column part 2 and of the steering wheel 3 is performed with the pedal or pedals 17, 18 depressed. As soon as the steering wheel 3 and the upper steering column part 2 have reached the desired position, the pedals are released, whereby they are returned by means of corresponding restoring forces to their starting position, in which the adjusting cylinders 14, 15, and in particular their piston parts, are arrested. As a result, the kinematic pivoted lever mechanism is blocked in the set displacement position of the upper steering column part 2.

The steering wheel 3 is fastened by means of a retaining portion (not designated any more specifically) on an end region 20 of the upper steering column part 2. The end region 20 is preferably mounted in a rotationally movable manner about the steering axis 4 in relation to the upper steering column part 2.

Both the parallel rocker 9 and the forked link 8 are configured as perforated sections. The points of articulation 6, 7, 10, 11 and the pivot points 12, 13 are taken over by releasable screw connections. The perforations in the sections of the forked link 8 and the parallel rocker 9 serve for weight reduction.

A displacement of the steering wheel 3 and of the upper steering column part 2 in its height and/or its alignment in the longitudinal direction of the vehicle is also possible by operating a single adjusting cylinder 14, 15 in each case. The other adjusting cylinder 14, 15, respectively, remains arrested, so that for this case the respective pivot point 12, 13 represents a stationary pivoting point for the kinematic pivoted lever mechanism.

1. Steering column arrangement for a motor vehicle, in particular a tracked vehicle, with a steering wheel, assigned to which are means for the electrical or electronic transmission of steering movements of the steering wheel to a vehicle control system, and the steering wheel being arranged in a rotationally movable manner on an upper steering column part, which is held adjustably in relation to a lower steering column part arranged fixedly on the vehicle, wherein means for vertical adjustment and means for longitudinal adjustment are provided between the lower steering column part and the upper steering column part, in order to adjust the upper steering column part in its height and in its length in relation to the position of the driver's seat.

2. Steering column arrangement according to claim 1, wherein the means for vertical adjustment and the means for longitudinal adjustment comprise a kinematic pivoted lever mechanism, by means of which the upper steering column part is articulated on the lower steering column part.

3. Steering column arrangement according to claim 2, wherein the kinematic pivoted lever mechanism is assigned at least one blocking means, in order to arrest the upper steering column part in a functional position in relation to the lower steering column part.

4. Steering column arrangement according to claim 3, wherein the kinematic pivoted lever mechanism is assigned at least one driving means, which is provided for the powered assistance or actuation of the kinematic pivoted lever mechanism.

5. Steering column arrangement according to claim 4, wherein actuating means that can be operated by an operator are provided for the blocking and/or driving means.

6. Steering column arrangement according to claim 1, wherein the means for vertical adjustment and the means for longitudinal adjustment are respectively assigned a separate driving unit, which can be individually activated by a separate actuating means in each case.

7. Steering column arrangement according to claim 4, wherein hydraulically or pneumatically actuated adjusting cylinder is provided as the driving means or as the blocking means.

8. Steering column arrangement according to claim 2, wherein the kinematic pivoted lever mechanism has a parallelogram linkage unit.

9. Steering column arrangement according to claim 2, wherein the kinematic pivoted lever mechanism has a supporting lever, which is articulated in a pivotably movable manner on the upper steering column part on the one hand and on the lower steering column part on the other hand.

10. Steering column arrangement according to claim 5, wherein the actuating means is formed as a pedal.
